(19) United States
(12) Patent Application Publication
(10) Pub. No.: US 2021/0014734 A1
(43) Pub. Date: Jan. 14, 2021

(54) APPARATUS AND METHOD FOR ACCESS TRAFFIC STEERING, SWITCHING, AND/OR SPLITTING OPERATION

(71) Applicant: GUANGDONG OPPO MOBILE TELECOMMUNICATIONS CORP., LTD., Dongguan (CN)

(72) Inventor: JIANHUA LIU, Dongguan (CN)

(21) Appl. No.: 17/028,721

(22) Filed: Sep. 22, 2020

Related U.S. Application Data
(63) Continuation of application No. PCT/CN2019/081295, filed on Apr. 3, 2019.
(60) Provisional application No. 62/652,405, filed on Apr. 4, 2018.

(51) Int. Cl. H04W 28/08; H04W 28/12

(52) U.S. Cl. CPC H04W 28/0942; H04W 28/0967; H04W 28/12

(57) ABSTRACT

An apparatus and a method for access traffic steering, switching, and/or splitting (ATSSS) operation are provided. The method for access traffic steering, switching, and/or splitting (ATSSS) operation of a user equipment includes establishing a connection over a plurality of different network accesses and configuring an ATSSS rule when the connection over the different network accesses is established.

### CROSS-REFERENCE TO RELATED APPLICATIONS

The present application is a continuation application of International PCT Application No. PCT/CN2019/081295 having an international filing date of Apr. 3, 2019, which claims priority to U.S. provisional application No. 62/652,405, filed on Apr. 4, 2018. The present application claims priority and the benefit of the above-identified applications and the above-identified applications are incorporated by reference herein in their entirety.

### BACKGROUND OF DISCLOSURE

### 1. Field of Disclosure

The present disclosure relates to the field of communication systems, and more particularly, to an apparatus and a method for access traffic steering, switching, and/or splitting (ATSSS) operation.

### 2. Description of Related Art

In recent years, mobile telecommunications carriers have experienced a dramatic increase in traffic on their networks, and this trend will likely continue. This increase in traffic has been caused in part by an increased adoption of smartphones and other devices that rely on mobile telecommunications networks, and a migration of many customers from utilizing landline telecommunication services to utilizing mobile telecommunication services for their communications needs. To meet demands of higher traffic and to improve an end user experience, mobile telecommunications carriers are examining mechanisms by which to improve network efficiency, network capacity, and the end user experience, while keeping operational costs at a level conducive to maintaining competitive rates for services they provide.

Therefore, there is a need for an apparatus and a method for access traffic steering, switching, and/or splitting (ATSSS) operation.

### SUMMARY

An object of the present disclosure is to propose an apparatus and a method for access traffic steering, switching, and/or splitting (ATSSS) operation capable of providing a good communication performance and high reliability and providing a solution that how the ATSSS is executed based on the link quality detection and feedback.

In a first aspect of the present disclosure, a user equipment (UE) for access traffic steering, switching, and/or splitting (ATSSS) operation includes a memory, a transceiver, and a processor coupled to the memory and the transceiver. The processor is configured to establish a connection over a plurality of different network accesses and configure an ATSSS rule when the connection over the different network accesses is established.

In a second aspect of the present disclosure, a method for access traffic steering, switching, and/or splitting (ATSSS) operation of a user equipment includes establishing a connection over a plurality of different network accesses and configuring an ATSSS rule when the connection over the different network accesses is established.

In a third aspect of the present disclosure, a network node for access traffic steering, switching, and/or splitting (ATSSS) operation includes a memory, a transceiver, and a processor coupled to the memory and the transceiver. The processor is configured to configure an ATSSS rule and implement an ATSSS operation based on the ATSSS rule and a status of a network.

In a fourth aspect of the present disclosure, a method for access traffic steering, switching, and/or splitting (ATSSS) operation of a network node includes configuring an ATSSS rule and implementing an ATSSS operation based on the ATSSS rule and a status of a network.

In a fifth aspect of the present disclosure, a non-transitory machine-readable storage medium has stored thereon instructions that, when executed by a computer, cause the computer to perform the above method.

In a sixth aspect of the present disclosure, a terminal device includes a processor and a memory configured to store a computer program. The processor is configured to execute the computer program stored in the memory to perform the above method.

In a seventh aspect of the present disclosure, a network node includes a processor and a memory configured to store a computer program. The processor is configured to execute the computer program stored in the memory to perform the above method.

### BRIEF DESCRIPTION OF DRAWINGS

In order to more clearly illustrate the implementations of the present disclosure or related art, the following figures will be described in the implementations are briefly introduced. It is obvious that the drawings are merely some implementations of the present disclosure, a person having ordinary skill in this field can obtain other figures according to these figures without paying the premise.

FIG. 1 is a block diagram of a user equipment and a network node for access traffic steering, switching, and/or splitting (ATSSS) operation according to an implementation of the present disclosure.

FIG. 2 is a flowchart illustrating a method for access traffic steering, switching, and/or splitting (ATSSS) operation of a user equipment according to an implementation of the present disclosure.

FIG. 3 is a flowchart illustrating a method for access traffic steering, switching, and/or splitting (ATSSS) operation of a network node according to an implementation of the present disclosure.

FIG. 4 is a schematic diagram illustrating an ATSSS architecture according to an implementation of the present disclosure.

FIG. 5 is a schematic diagram illustrating a user plane protocol stack for a third generation partnership project (3GPP) access according to an implementation of the present disclosure.

FIG. 6 is a schematic diagram illustrating a user plane protocol stack for non-3GPP access according to an implementation of the present disclosure.

FIG. 7 is a schematic diagram of an exemplary illustration of a downlink ATSSS execution procedure according to an implementation of the present disclosure.

FIG. 8 is a schematic diagram of an exemplary illustration of an uplink ATSSS execution procedure according to an implementation of the present disclosure.

FIG. 9 is a block diagram of a system for wireless communication according to an implementation of the present disclosure.

### DETAILED DESCRIPTION OF IMPLEMENTATIONS

Implementations of the present disclosure are described in detail with the technical matters, structural features, achieved objects, and effects with reference to the accompanying drawings as follows. Specifically, the terminologies in the implementations of the present disclosure are merely for describing the purpose of the certain implementation, but not to limit the disclosure.

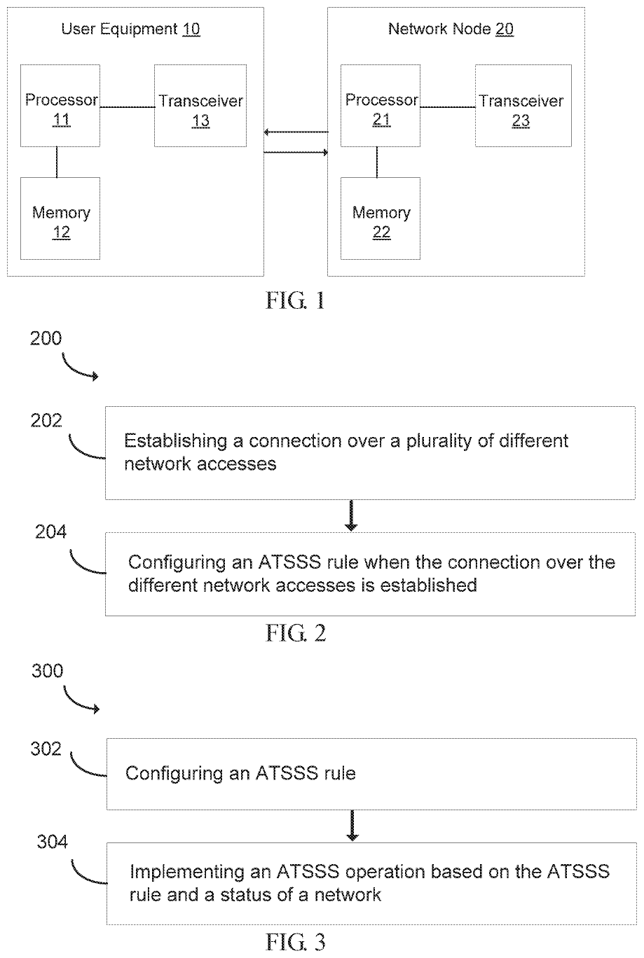

FIG. 1 illustrates that, in some implementations, a user equipment (UE) 10 and a network node 20 for access traffic steering, switching, and/or splitting (ATSSS) operation according to an implementation of the present disclosure are provided. The UE 10 may include a processor 11, a memory 12, and a transceiver 13. The network node 20 may include a processor 21, a memory 22 and a transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include an application-specific integrated circuit (ASIC), other chipsets, logic circuit and/or data processing devices. The memory 12 or 22 may include a read-only memory (ROM), a random access memory (RAM), a flash memory, a memory card, a storage medium and/or other storage devices. The transceiver 13 or 23 may include baseband circuitry to process radio frequency signals. When the implementations are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21, in which those can be communicatively coupled to the processor 11 or 21 via various means are known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) release 14, 15, and beyond. UEs communicate with each other directly via a sidelink interface such as a PC5 interface.

A solution of an implementation of the present disclosure is to propose an apparatus and a method for access traffic steering, switching, and/or splitting (ATSSS) operation capable of providing a good communication performance and high reliability and providing a solution that how the ATSSS is executed based on the link quality detection and feedback. The solution tends to address the procedure of data is steered, switched, and/or split between different access radio access technologies (RATs), e.g. a 3GPP RAT and a non-3GPP RAT.

In some implementations, the processor 11 is configured to establish a connection over a plurality of different network accesses and configure an ATSSS rule when the connection over the different network accesses is established.

In some implementations, the processor 11 is configured to implement an ATSSS operation based on the ATSSS rule and a status of a network, the status of the network is associated with the connection over the different network accesses. The connection is a protocol data unit (PDU) session, and the different network accesses include a third generation partnership project (3GPP) access and a non-3GPP access. The processor 11 is configured to control the transceiver 13 to receive an ATSSS rule and operation command from a session management function (SMF) of a network node. The processor 11 is configured to perform a link detection and provide, to the SMF, a measurement result of the link detection via a control plane, the processor 11 is configured to control the transceiver to receive an updated ATSSS rule based on the measurement result of the link detection from the SMF, and the processor 11 is configured to apply the updated ATSSS rule.

In some implementations, when uplink data arrives from the network node 20 to the transceiver 13, the processor 11 determines an appropriate access path based on the ATSSS rule. The UE 10 further includes a traffic flow control protocol (TFCP) entity configured to implement the ATSSS rule. The processor 11 is configured to control the transceiver 13 to send the uplink data to a user plane function (UPF) of the network node 20 via a selected access path determined by the processor 11. The processor 11 is configured to implement the updated ATSSS rule and adjust the selected access path for service. The processor 11 adjusting the selected access path for the service includes switching the selected access path from one access to another one or start/stop splitting operation for the uplink data based on the updated ATSSS rule. The processor 11 is configured to control the transceiver 13 to send the uplink data to the UPF via the adjusted access path.

In some implementations, the processor 21 is configured to configure an ATSSS rule and implement an ATSSS operation based on the ATSSS rule and a status of a network.

In some implementations, the status of the network is associated with a connection over a plurality of different network accesses. The connection is a protocol data unit (PDU) session, and the different network accesses include a third generation partnership project (3GPP) access and a non-3GPP access. The ATSSS rule is configured at a session management function (SMF) of the network node 20. The network node further includes an ATSSS control functionality entity in the SMF configured to determine to perform the ATSSS operation. The SMF is configured to configure an ATSSS rule and operation command to the UE 10 or a user plane function (UPF) of the network node 20.

In some implementations, the SMF is configured to update the ATSSS rule based on a measurement result of a link detection from the UE 10 or the UPF and configure the updated ATSSS rule to the UE 10 or the UPF. When downlink data arrives, the UPF determines an appropriate access path based on the ATSSS rule. The UPF is configured to send the downlink data to the UE 10 via a selected access path. The UPF is configured to perform a path performance measurement and report a result to the SMF based on a configured report condition. The SMF is configured to update the ATSSS rule based on a feedback from the UE 10.

In some implementations, the SMF is configured to transfer the feedback from the UE 10 to the UPF. The SMF is configured to send the update ATSSS rule to the UPF. The UPF is configured to adjust a path based on the updated ATSSS rule or based on the feedback from UE 10. The UPF adjusting the path includes switching the path from one access to another one or start/stop splitting operation for the downlink data. The UPF sends the downlink data to the UE 10 via an adjusted access path.

FIG. 2 illustrates a method 200 for access traffic steering, switching, and/or splitting (ATSSS) operation of a user equipment according to an implementation of the present disclosure. The method 200 includes: a block 202, establishing a connection over a plurality of different network accesses, and a block 204, configuring an ATSSS rule when the connection over the different network accesses is established.

In some implementations, the method 200 further includes implementing an ATSSS operation based on the ATSSS rule and a status of a network, and the status of the network is associated with the connection over the different network accesses. The connection is a protocol data unit (PDU) session, and the different network accesses include a third generation partnership project (3GPP) access and a non-3GPP access. The method 200 further includes receiving an ATSSS rule and operation command from a session management function (SMF) of a network node. The method 200 further includes performing a link detection and provide, from the UE to the SMF, a measurement result of the link detection via a control plane, receiving an updated ATSSS rule based on the measurement result of the link detection from the SMF, and applying the updated ATSSS rule.

In some implementations, when uplink data arrives from the network node to the UE, the method includes determining an appropriate access path based on the ATSSS rule. In some implementations, the method 200 further includes implementing the ATSSS rule by a traffic flow control protocol (TFCP) entity in the UE. In some implementations, the method 200 further includes sending the uplink data to a user plane function (UPF) of the network node via a selected access path determined by the UE. In some implementations, the method 200 further includes implementing the updated ATSSS rule and adjusting the selected access path for service. Adjusting the selected access path for the service includes switching the selected access path from one access to another one or start/stop splitting operation for the uplink data based on the updated ATSSS rule. In some implementations, the method 200 further includes sending the uplink data to the UPF via the adjusted access path.

FIG. 3 illustrates a method 300 for access traffic steering, switching, and/or splitting (ATSSS) operation of a network node according to an implementation of the present disclosure. The method 300 includes: a block 302, configuring an ATSSS rule, and a block 304, implementing an ATSSS operation based on the ATSSS rule and a status of a network.

In some implementations, the status of the network is associated with a connection over a plurality of different network accesses. The connection is a protocol data unit (PDU) session, and the different network accesses include a third generation partnership project (3GPP) access and a non-3GPP access. The ATSSS rule is configured at a session management function (SMF) of the network node. In some implementations, the method 300 further includes determining to perform the ATSSS operation by an ATSSS control functionality entity in the SMF. In some implementations, the method 300 further includes configuring an ATSSS rule and operation command from the SMF to a user equipment (UE) or a user plane function (UPF) of the network node.

In some implementations, the method 300 further includes updating the ATSSS rule based on a measurement result of a link detection from the UE or the UPF and configuring the updated ATSSS rule to the UE or the UPF by the SMF. When downlink data arrives, the method includes determining an appropriate access path based on the ATSSS rule by the UPF.

In some implementations, the method 300 further includes sending the downlink data to the UE via a selected access path by the UPF. In some implementations, the method 300 further includes performing a path performance measurement and report a result to the SMF based on a configured report condition by the UPF. In some implementations, the method 300 further includes updating the ATSSS rule based on a feedback from the UE by the SMF. In some implementations, the method 300 further includes transferring the feedback from the UE to the UPF by the SMF.

In some implementations, the method 300 further includes sending the update ATSSS rule to the UPF by the SMF. In some implementations, the method 300 further includes adjusting a path based on the updated ATSSS rule or based on the feedback from UE by the UPF. The UPF adjusting the path includes switching the path from one access to another one or start/stop splitting operation for the downlink data. In some implementations, the method 300 further includes sending the downlink data to the UE via an adjusted access path by the UPF.

For purposes of the implementation of the present disclosure, terms and definitions that can be adopted in 3GPP specification are given below.

Access traffic steering: A procedure that selects an access network for a new data flow and transfers traffic of a data flow over a selected access network. The access traffic steering is applicable between 3GPP and non-3GPP accesses.

Access traffic switching: A procedure that moves all traffic of an ongoing data flow from one access network to another access network in a way that maintains continuity of the data flow. The access traffic switching is applicable between 3GPP and non-3GPP accesses.

Access traffic splitting: A procedure that splits traffic of a data flow across multiple access networks. When traffic splitting is applied to a data flow, some traffic of the data flow is transferred via one access and some other traffic of the same data flow is transferred via another access. The access traffic splitting is applicable between 3GPP and non-3GPP accesses.

Mufti-access PDU session: A PDU session whose traffic can be sent over a 3GPP access, non-3GPP access, or both accesses.

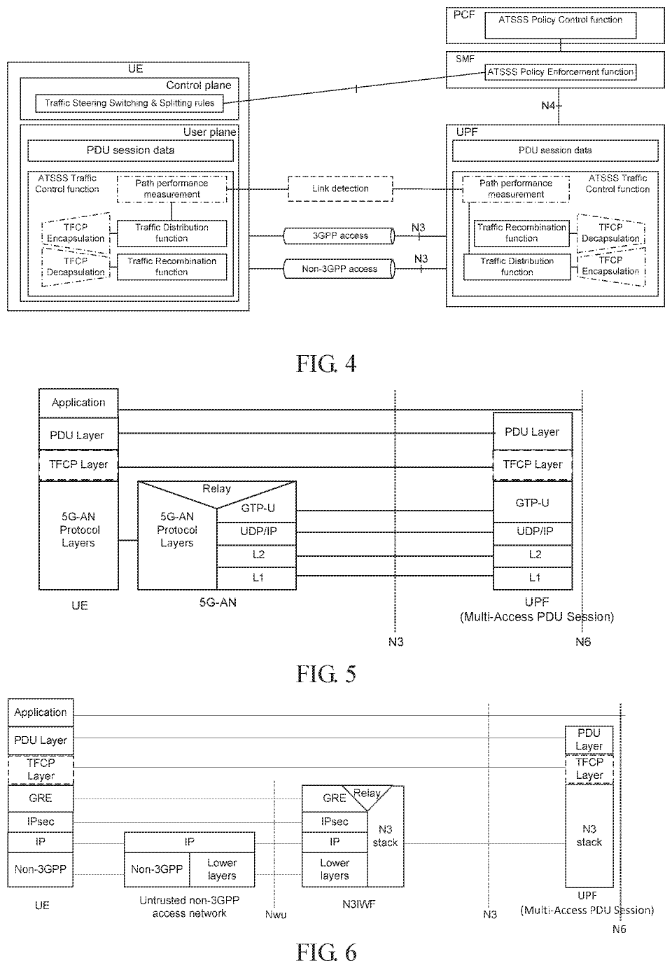

FIG. 4 illustrates an ATSSS architecture according to an implementation of the present disclosure.

An ATSSS policy control function in a policy control function (PCF) defines following policies according to application-specific information, a UE subscription data, user preference, local policy, or any combination of them.

Traffic steering policy: This rule is used to select an access when initiating a new data flow. Traffic switching policy: This rule is used to determine when a data flow should be moved from 3GPP to non-3GPP or vice versa. Traffic splitting policy: This rule is used to determine when a data flow should be split across 3GPP and non-3GPP. The above policies may determine an appropriate access by the following principle, for example:

Least loaded first: The least loaded path is selected to forward traffic. For example, in traffic steering policy, the least loaded path is selected to initiate a new data flow. Best performance first: The best performance path is selected to forward traffic, applicable for the traffic steering policy, or the traffic switching policy. Load balance: Traffic is split on both access paths, allowing for equal or unequal traffic distribution, e.g. based on weights. Traffic/application type: Special traffic types or applications are bound to a given access path, as defined by the user or the operator. User location information: Traffic is steered or switched to 3GPP or non-3GPP network at the specific location, e.g. non-3GPP is provided higher priority at home or at office.

An ATSSS policy enforcement function in a SMF is responsible for ATSSS policies enforcement and session management of all PDU sessions between 5G network core (5GC) and a UE. Policy enforcement function can receive the ATSSS policies from the PCF via N7 and generates ATSSS rules to control the traffic by conveying ATSSS rules to a UPF over N4. The ATSSS policy enforcement function can also provide an ATSSS PDU session related rules to the UE during a PDU session establishment and a PDU session modification.

An ATSSS traffic control function contains the following functionality:

Traffic distribution function: Distribute traffic onto the appropriate 3GPP or non-3GPP access path. The Traffic distribution function forwards the traffic either over the 3GPP or non-3GPP access or both. It determines which path may be used for an incoming packet given traffic distribution based on the ATSSS rules and the state of the network. More specifically, the ATSSS rules are from the SMF, the performance of each access path is reported by the path performance measurement function.

Traffic recombination function: Recombine traffic flows received from the 3GPP and non3GPP access. The Traffic recombination function receives the traffic from both 3GPP and non-3GPP access. This function provides reordering of potential out of order packets based on the sequence number in a traffic flow control protocol (TFCP) layer.

Path performance measurement function: Monitor the performance of the available path and report this information to the traffic distribution function. The path performance measurement function provides input to the traffic distribution function about the path performance information. The path performance is notified via control plane by the traffic usage report. The path performance may be measured by bandwidth, loss rate or/and latency.

TFCP encapsulation/decapsulation function: Encapsulate/decapsulate a TFCP header. The TFCP encapsulation/decapsulation function adds or removes the TFCP header for the PDU session data. The TFCP layer may be subjected to per PDU session, per SDF based on the ATSSS rules. According to sequence of packets received from the upper layer, the packet encapsulation function set the sequence number in the TFCP header.

FIG. 5 illustrates a user plane protocol stack for a third generation partnership project (3GPP) access according to an implementation of the present disclosure. FIG. 6 is a schematic diagram illustrates a user plane protocol stack for non-3GPP access according to an implementation of the present disclosure. In some implementations, FIGS. 5 and 6 each illustrates a protocol stack for a user plane transport related with a PDU session. In these solutions, traffic between a UE and a UPF is tunnelled via a TFCP layer or a network convergence protocol (NCP) layer.

In some implementations, an ATSSS execution procedure descripts how the ATSSS is executed based on link quality detection and feedback. A UPF or a UE performs link detection and provides a measurement result to a SMF via control plane, the SMF updates an ATSSS rule based on the received measurement results from the UPF or the UE and configures the updated ATSSS rule to the UE or the UPF. The UE or the UPF apply the updated ATSSS rule. The detailed call flow can be illustrated in the following procedures, representing the downlink and uplink procedure independently.

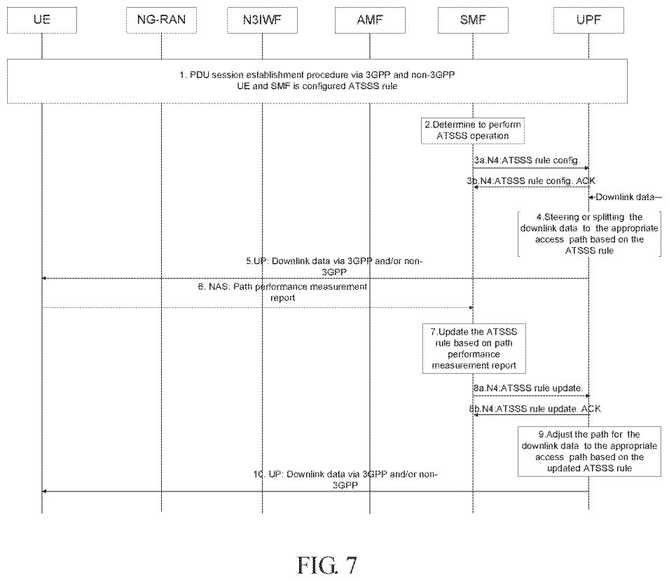

FIG. 7 illustrates a downlink ATSSS execution procedure according to an implementation of the present disclosure. The procedure is applied for ATSSS operation, in which a UPF implements the ATSSS operation based on an ATSSS policy (such as an ATSSS rule) and a status of a network. In this procedure, it is assumed that UE has already established PDU sessions over 3GPP and non-3GPP accesses.

Step 1. UE establishes the PDU sessions over 3GPP and non-3GPP access. And the ATSSS policy is configured at the UE and SMF. Step 2. An ATSSS control functionality entity in the SMF determines to perform ATSSS operation. Step 3. SMF configures the ATSSS policy and operation command to the UPF. Step 4. When downlink data arrives, the UPF entity determines the appropriate access path based on the ATSSS policy. Step 5. UPF sends the downlink data to the UE via the selected access path. Step 6. UE performs path performance measurement, e.g. the data loss rate, latency, the radio signal quality and reports the results to the SMF based on the configured report condition. Step 7. SMF update the ATSSS policy based on UE feedback; alternatively, SMF transfer the feedback in step 6 to UPF. Step 8a. SMF sends the update ATSSS policy to the UPF. Step 8b. The UPF sends a response regarding the update ATSSS policy to the SMF. Step 9. UPF adjusts the path, e.g. switching the path from one access to another one or start/stop splitting operation for the downlink data based on the updated ATSSS rule; or based on the feedback from UE. Step 10. UPF sends the downlink data to the UE via the adjusted access path.

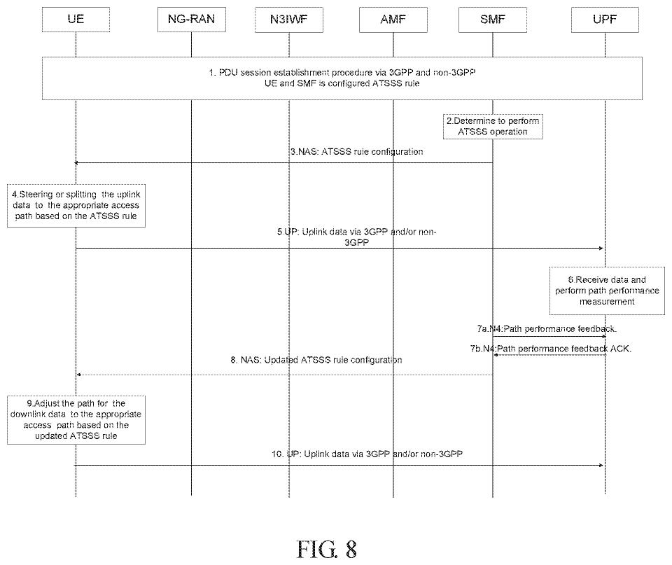

FIG. 8 illustrates an uplink ATSSS execution procedure according to an implementation of the present disclosure. The procedure is applied for ATSSS operation uplink transmission, in which the UE implements the ATSSS operation based on the ATSSS policy and the status of the network. In this procedure, it is assumed that UE has already established PDU sessions over 3GPP and non-3GPP access.

Step 1. UE establishes the PDU sessions over 3GPP and non-3GPP access. And the ATSSS policy is configured at the UE and SMF. Step 2. The ATSSS control functionality entity in the SMF determines to perform ATSSS operation. Step 3. SMF configures the ATSSS policy and operation command to the UE. Step 4. When uplink data arrives, the UE entity determines the appropriate access path based on the ATSSS policy. Step 5. UE sends the uplink data to the UPF via the selected access path. Step 6. UPF performs path performance measurement, e.g., the data loss rate, latency, the radio signal quality, and reports the results to the SMF based on the configured report condition. Steps 7a, 7b, and 8. SMF updates the ATSSS policy based on UPF feedback; alternatively, SMF transfer the feedback in step 6 to UE. Step 9. UE adjusts the path, e.g., switching the path from one access to another one or start/stop splitting operation for the uplink data based on the updated ATSSS rule; or based on the feedback from UE. Step 10. UE sends the uplink data to the UPF via the adjusted access path.

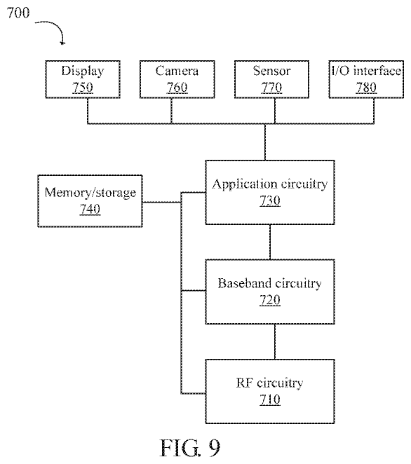

FIG. 9 is a block diagram of an example system 700 for wireless communication according to an implementation of the present disclosure. Implementations described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

In some implementations, the performance of an available path is measured and reported to the traffic distribution function by the path performance measurement function. The path performance measurement function is deployed in the UE and the UPF, which means both the UE and the UPF could initiate the path performance measurement, and the measurement result is used for traffic distribution determination. The performance measurement parameters include access agnostic parameters and access specific parameters (optional). The access agnostic parameters include the RTT, jitter, and packet loss ratio parameters, which could be used to justify the path performance of 3GPP access and Non 3GPP access respectively. The access specific parameters include the parameters which could be used to verify the load or signal strength of each access, e.g. reference signal received power (RSRP)/reference signal received power quality (RSRQ) for 3GPP access, and the available bandwidth for non 3GPP access. Besides, the performance measurement policies, e.g. access type for measurement, measurement period, report threshold and/or report period, are also included in the performance measurement parameters.

The measurement granularity could be per PDU session or per quality of service (QoS) flow for each access. During the PDU session establishment/modification procedure, the SMF provides path performance measurement parameters for the PDU session or QoS flows, traffic of which is potentially to be distributed, to the UE in the PDU session establishment/modification Accept via NAS message. Besides, the SMF also provides the PDU session identity (ID) or a QoS flow ID (QFI) along with path performance measurement parameters to indicate to the UE to bind the path performance measurement parameters with the corresponding PDU session or the QoS flow to be measured. After receiving the performance measurement parameters for the PDU session or the QoS flow to be measured, the UE initiates path performance measurement for the PDU session or QoS flow based on the path performance measurement policy.

The UE generates the TFCP echo request message based on the measurement period, and sends the TFCP echo request message via the 3GPP access and/or non 3GPP access periodically. When the UPF receives the TFCP echo request message from the 3GPP and/or non 3GPP access node respectively, the UPF generates the TFCP echo response message and sends back via the corresponding access node. Round trip time (RTT) and jitter could be measured via the TFCP echo request/response messages. Besides, the UE and the UPF could exchange the sending and receiving packet data statistics to get the packet loss ratio result.

The measurement traffic per QoS flow can be implemented in a way without impact on the link performance for the QoS flow, e.g. the interval of sending TFCP echo request/response message pair for path performance measurement can be set to a couple of minutes. Since the link performance would not deteriorates gradually, interval set to minutes(s) for path performance detection can be enough for ATSSS.

The UE can measure the radio signal strength for the 3GPP access and the available bandwidth of Non 3GPP access. Based on the report threshold or period of performance measurement parameters, the UE could provide the measurement result to the UPF, via user plane directly or via control plane to SMF and then from SMF to the UPF.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some implementations, the baseband circuitry may provide for communication compatible with one or more radio technologies. For example, in some implementations, the baseband circuitry may support communication with an evolved universal terrestrial radio access network (EUTRAN) and/or other wireless metropolitan area networks (WMAN), a wireless local area network (WLAN), a wireless personal area network (WPAN). Implementations in which the baseband circuitry is configured to support radio communications of more than one wireless protocol may be referred to as multi-mode baseband circuitry.

In various implementations, the baseband circuitry 720 may include circuitry to operate with signals that are not strictly considered as being in a baseband frequency. For example, in some implementations, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various implementations, the RF circuitry may include switches, filters, amplifiers, etc. to facilitate the communication with the wireless network.

In various implementations, the RF circuitry 710 may include circuitry to operate with signals that are not strictly considered as being in a radio frequency. For example, in some implementations, RF circuitry may include circuitry to operate with signals having an intermediate frequency, which is between a baseband frequency and a radio frequency.

In various implementations, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some implementations, the electronic device circuitry may be implemented in, or functions associated with the circuitry may be implemented by, one or more software or firmware modules.

In some implementations, some or all of the constituent components of the baseband circuitry, the application circuitry, and/or the memory/storage may be implemented together on a system on a chip (SOC).

The memory/storage 740 may be used to load and store data and/or instructions, for example, for systems. The memory/storage for one implementation may include any combination of suitable volatile memory, such as dynamic random access memory (DRAM)), and/or non-volatile memory, such as flash memory.

In various implementations, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various implementations, the sensor 770 may include one or more sensing devices to determine environmental conditions and/or location information related to the system. In some implementations, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various implementations, the display 750 may include a display, such as a liquid crystal display and a touch screen display. In various implementations, the system 700 may be a mobile computing device such as, but not limited to, a laptop computing device, a tablet computing device, a netbook, an ultrabook, a smartphone, etc. In various implementations, system may have more or less components, and/or different architectures. Where appropriate, methods described herein may be implemented as a computer program. The computer program may be stored on a storage medium, such as a non-transitory storage medium.

In the implementation of the present disclosure, an apparatus and a method for access traffic steering, switching, and/or splitting (ATSSS) operation capable of providing a good communication performance and high reliability and providing a solution that how the ATSSS is executed based on the link quality detection and feedback are provided. A solution of the implementation tends to address the procedure of data is steered, switched, and/or split between different access radio access technologies (RATs), e.g. a 3GPP RAT and a non-3GPP RAT.

The implementation of the present disclosure is a combination of techniques/processes that can be adopted in 3GPP specification to create an end product.

A person having ordinary skill in the art understands that each of the units, algorithm, and steps described and disclosed in the implementations of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned implementation since the working processes of the above-mentioned system, device, and unit are basically the same. For easy description and simplicity, these working processes will not be detailed.

It is understood that the disclosed system, device, and method in the implementations of the present disclosure can be realized with other ways. The above-mentioned implementations are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the implementations. Moreover, each of the functional units in each of the implementations can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the implementations of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred implementations, it is understood that the present disclosure is not limited to the disclosed implementations but is intended to cover various arrangements made without departing from the scope of the broadest interpretation of the appended claims.

What is claimed is:

1. A user equipment (UE) for access traffic steering, switching, and/or splitting (ATSSS) operation, comprising:
a memory;
a transceiver; and
a processor coupled to the memory and the transceiver,
wherein the processor is configured to:
establish a connection over a plurality of different network accesses; and
configure an ATSSS rule when the connection over the different network accesses is established.

2. The UE of claim 1, wherein the processor is configured to implement an ATSSS operation based on the ATSSS rule and a status of a network, the status of the network is associated with the connection over the different network accesses.

3. The UE of claim 1, wherein the connection is a protocol data unit (PDU) session, and the different network accesses comprise a third generation partnership project (3GPP) access and a non-3GPP access

4. The UE of claim 1, wherein the processor is configured to control the transceiver to receive an ATSSS rule and operation command from a session management function (SMF) of a network node.

5. The UE of claim 1, wherein the processor is configured to perform a link detection and provide, to the SMF, a measurement result of the link detection via a control plane, the processor is configured to control the transceiver to receive an updated ATSSS rule based on the measurement result of the link detection from the SMF, and the processor is configured to apply the updated ATSSS rule.

6. The UE of claim 4, wherein when uplink data arrives from the network node to the transceiver, the processor determines an appropriate access path based on the ATSSS rule.

7. The UE of claim 6, further comprising a traffic flow control protocol (TFCP) entity configured to implement the ATSSS rule.

8. The UE of claim 6, wherein the processor is configured to control the transceiver to send the uplink data to a user plane function (UPF) of the network node via a selected access path determined by the processor.

9. The UE of claim 6, wherein the processor is configured to implement the updated ATSSS rule and adjust the selected access path for service.

10. The UE of claim 9, wherein the processor adjusting the selected access path for the service comprises switching the selected access path from one access to another one or start/stop splitting operation for the uplink data based on the updated ATSSS rule.

11. The UE of claim 10, wherein the processor is configured to control the transceiver to send the uplink data to the UPF via the adjusted access path.

12. A method for access traffic steering, switching, and/or splitting (ATSSS) operation of a user equipment (UE), comprising:
establishing a connection over a plurality of different network accesses; and
configuring an ATSSS rule when the connection over the different network accesses is established.

13. The method of claim 12, further comprising implementing an ATSSS operation based on the ATSSS rule and a status of a network, wherein the status of the network is associated with the connection over the different network accesses.

14. The method of claim 12, wherein the connection is a protocol data unit (PDU) session, and the different network accesses comprise a third generation partnership project (3GPP) access and a non-3GPP access.

15. The method of claim 12, further comprising receiving an ATSSS rule and operation command from a session management function (SMF) of a network node.

16. The method of claim 12, further comprising performing a link detection and provide, from the UE to the SMF, a measurement result of the link detection via a control plane, receiving an updated ATSSS rule based on the measurement result of the link detection from the SMF, and applying the updated ATSSS rule.

17. The method of claim 15, wherein when uplink data arrives from the network node to the UE, the method comprises determining an appropriate access path based on the ATSSS rule.

18. The method of claim 17, further comprising implementing the ATSSS rule by a traffic flow control protocol (TFCP) entity in the UE.

19. The method of claim 17, further comprising sending the uplink data to a user plane function (UPF) of the network node via a selected access path determined by the UE.

20. The method of claim 17, further comprising implementing the updated ATSSS rule and adjusting the selected access path for service.
